(19) United States
(12) Patent Application Publication
(10) Pub. No.: US 2025/0244937 A1
(43) Pub. Date: Jul. 31, 2025

(54) TECHNIQUES FOR IMAGE PROCESSING OF NON-DESTRUCTIVE READOUTS

(71) Applicant: Apple Inc., Cupertino, CA (US)

(72) Inventors: Sivalogeswaran Ratnasingam, San Jose, CA (US); Anselm Grundhoefer, Campbell, CA (US); Manu Rastogi, San Jose, CA (US); Ameet Jain, Sunnyvale, CA (US)

(73) Assignee: Apple Inc., Cupertino, CA (US)

(21) Appl. No.: 18/989,646

(22) Filed: Dec. 20, 2024

Related U.S. Application Data
(60) Provisional application No. 63/626,874, filed on Jan. 30, 2024.

(51) Int. Cl. G06F 3/14; G06V 10/25; G06V 10/75; H04N 25/78

(52) U.S. Cl. CPC G06F 3/14; G06V 10/25; G06V 10/751; H04N 25/78

(57) ABSTRACT

In some implementations, the techniques may include performing a first readout of an image sensor to generate a first image frame, where the first readout is a first type of readout of the image sensor. In addition, the techniques may include identifying, by the first processor, one or more first regions of interest in the first image frame. The techniques may include performing a second readout of the image sensor to generate a second image frame, where the second readout is a second type of readout of the image sensor of a device, and the second image frame may include the one or more first regions of interest, where the electronic device has a display and the second image frame is smaller than the display. Moreover, the techniques may include presenting the second image frame on the display.

### CROSS-REFERENCES TO OTHER APPLICATIONS

This application claims priority to U.S. Provisional Application No. 63/626,874, for “TECHNIQUES FOR IMAGE PROCESSING OF NON-DESTRUCTIVE READOUTS” filed on Jan. 30, 2024, which is herein incorporated by reference in its entirety for all purposes.

### BACKGROUND

Many head mounted display devices are designed to perform energy intensive image processing techniques. In some designs, the display is worn throughout the day and augments a user's senses during their routine. To perform these tasks, the display must have enough battery capacity to last through the day, but the display must also be light enough to be comfortably worn for hours at a time. Accordingly, head mounted displays may be power constrained and techniques to improve a display's energy efficiency are desirable.

### SUMMARY

Image processing can be made more energy efficient by employing both non-destructive and destructive readouts from image sensors. A readout is destructive if the data being read is erased. Specifically, a destructive readout involves filling and depleting an image sensor's charge well. In contrast, a non-destructive readout can allow for one or more image frames to be read without depleting the charge in the sensor's charge well. Destructive readouts consume more power than non-destructive readouts, which can be read multiple times without having to be emptied of charge.

To save power, destructive readouts can be limited to regions of interest within the image sensor's field of view. These regions of interest can be identified using lower quality (e.g., lower signal-to-noise ratio) non-destructive readouts, and once identified, destructive readouts are used to capture a higher quality image (e.g., higher signal-to-noise ratio) of the identified regions. In this way, the head mounted display can save power by limiting higher quality, and more power hungry, destructive readouts to the most important parts of the image (e.g. sensor representation). A region of interest can be a region of the display corresponding to the user's gaze or one or more identified objects. For example, the head mounted display may identify an area corresponding to the user's car keys, or a moving ball, as a region of interest. In this way, the head mounted display can conserve power by limiting destructive readouts.

The techniques may include performing a first readout of an image sensor to generate a first image frame having a sensor representation of a physical environment, where the first readout is a first type of readout of the image sensor. Techniques may also include identifying, by the in-sensor processor, one or more first regions of interest in the first image frame, the one or more regions of interest corresponding to one or more regions of the physical environment. Techniques may furthermore include performing a second readout of the image sensor to generate a second image frame, where the second readout is a second type of readout of the image sensor, and the second image frame may include the one or more first regions of interest, where the electronic device has a display and the second image frame is smaller than the display. Techniques may in addition include presenting the second image frame on the display. Other embodiments of this aspect include corresponding methods, computer systems, apparatus, and computer programs recorded on one or more non-transitory computer storage devices or memories, each configured to perform the actions of the techniques.

Implementations may include one or more of the following features. Techniques where presenting the second image frame may include: performing image processing techniques on the second image frame; and presenting the processed second image frame on the display. Techniques where the image processing techniques may include low-light image enhancement techniques. Techniques where the destructive readout consumes more power than the non-destructive readout. Techniques where the first readout is performed in response to a request for augmented reality functionality. Techniques where the first type of readout is a non-destructive readout. Techniques where the second type of readout is a destructive readout.

Techniques may include: performing a third readout of the image sensor to generate a third image frame, where the third readout is the first type of readout of the image sensor, identifying one or more second regions of interest in the third image frame; performing a fourth readout of the image sensor to generate a fourth image frame, where the fourth readout is a the second type of readout of the image sensor, and the fourth image frame may include the one or more second regions of interest, where the fourth image frame is smaller than the display; combining the second image frame and the fourth image frame to generate a displayed image frame; and presenting the displayed image frame on the display.

Techniques where identifying the one or more second regions of interest may include: identifying one or more objects in both the first image frame and the third image frame; determining a first set of coordinates for the one or more objects in the first image frame; determining a second set of coordinates for the one or more objects in the third image frame; comparing the first set of coordinates and the second set of coordinates to identify a subset of the one or more objects that have changed coordinates between the first image frame and the third image frame; and identifying the subset of the one or more objects as the one or more second regions of interest. Techniques where the electronic device is a head mounted display device having at least the display, the image sensor, a battery, and a motion sensor. Techniques where the second image frame is presented for a duration of the frame rate. Techniques where the first readout is performed, the one or more first regions of interest are identified, and the second image frame is generated within the duration of the frame rate. Techniques where the duration of the frame rate is a time between presented image fames.

Techniques may include: detecting, by the motion sensor, a change of a pose of the head mounted display device; identifying one or more second regions of interest based at least in part on the change of the pose, where the one or more second regions of interest are not present in the second image frame; performing a fourth readout of the image sensor to generate a fourth image frame, where the fourth readout is the second type of readout of the image sensor, and the fourth image frame may include the one or more second regions of interest, where the fourth image frame is smaller than the display; combining the second image frame and the fourth image frame to generate a displayed image frame; and presenting the displayed image frame on the display. Techniques where the display is a transparent display permitting a user of the electronic device to simultaneously view a displayed image frame and the physical environment. Techniques where presenting the second image frame may include: superimposing the second image frame on the one or more first regions of interest corresponding to the one or more regions of the physical environment. Implementations of the described techniques may include hardware, a method or process, or a computer tangible medium.

### BRIEF DESCRIPTION OF THE DRAWINGS

FIG. 1 shows a simplified diagram of a head mounted display's field of view and field of measurement according to at least one embodiment.

FIG. 2 shows a simplified diagram of a region of interest according to at least one embodiment.

FIG. 3 shows a simplified diagram of an updated field of view according to at least one embodiment.

FIG. 4 is a simplified diagram 400 of an imaging system architecture according to at least one embodiment.

FIG. 5 is a simplified sequence diagram showing a technique for capturing a destructive readout of a region of interest according to an embodiment.

FIG. 6 is a simplified sequence diagram showing a technique for capturing a destructive readout in response to detected movement according to an embodiment.

FIG. 7 is a flowchart illustrating a method for performing techniques to trigger a destructive readout of an image sensor according to at least one embodiment.

FIG. 8 is a block diagram of an example electronic device according to at least one embodiment.

### DETAILED DESCRIPTION

Augmented reality functionality can involve creating composite images that combine captured images and depictions of the surrounding environment. A user can interact with these composite images, or scenes, using an electronic device. For example, augmented reality can be implemented by a head mounted display device, however, such devices are often power constrained. The device may minimize the number of captured images to conserve power. To reduce the number of captured images, a lower power non-destructive image sensor readout can be used to identify regions of interest, and higher power destructive image sensor readouts can capture images of these identified regions.

### I. Head Mounted Display Device

The head mounted display device can be an augmented reality device. Such devices display an enhanced depiction of a physical environment to their users. For example, the head mounted display device may present the user with an enhanced depiction of their current environment that substantially overlaps with the user's field of vision. This scene is rendered so that the user would see a similar view of the environment if they were not wearing the device. In essence, the user, when viewing the device's display, “sees through” the head mounted display device to view the environment. Such a head mounted display device can be implemented with a transparent display or an opaque display, but with a screen that displays images provided by cameras.

A user viewing their environment through a head mounted display device can be shown an enhanced or augmented depiction of their surroundings. For a transparent display, computer generated graphics can be superimposed on the physical environment seen through the device, and these augmented environments, also referred to as scenes, can be displayed to the user. In addition or alternatively, the graphics can be sensor representations of the physical environment that are augmented using image processing techniques, and, for example, a sensor representation of a low light environment can be brightened and superimposed on a transparent display to help a user see in the dark (e.g., using low-light image enhancement techniques).

### A. Combining Sensor Representations to Conserve Power

Capturing sensor representations with image sensors can be energy intensive, and the head mounted display can conserve power by reducing the size and frequency of the sensor readouts. To begin an augmented reality display, the head mounted display device can perform a readout corresponding to the device's display and the resulting sensor representation can be presented to the user as a scene. Over time, the scene view can be updated so that the user can view and interact with the physical environment. Many physical environments contain large static regions, and, for example, regions of an image corresponding to a room's walls may not change over time. Accordingly, the size of the sensor readout, and the corresponding power consumption, for each subsequent scene view can be reduced by combining static regions from previous image sensor readouts with newly captured regions of interest.

While sensor representations of static regions may be reused between scenes, other regions in the field of view may need to be captured for a new scene. These regions of interest can be areas where movement is detected, low light areas, objects of interest, detected text, an area corresponding to the user's gaze, salient regions (e.g., regions that visually contrast with their surroundings), or any area that is identified as an image processing target (e.g., a region upon which image processing techniques are performed). For example, a user may see an electronic device, such as a speaker, that can be controlled by the head mounted display device. The device may recognize the electronic device and graphically connect a computer generated menu to the device to indicate to the user that the electronic device is controllable.

In an illustrative example, a static user is using the head mounted display device to view a ball roll across a room. The room is a low light environment and an enhanced sensor representation of the ball, along with the rest of the physical environment, is shown on the display device to improve the user's view of their surroundings. The display device presents the enhanced scene at twenty frames a second, and, between each frame, the ball's position changes as it moves. A new representation of the ball needs to be shown at each frame to ensure that the sensor representation and the physical ball correspond. However, the majority of the scene remains static. Instead of capturing an image of the entire scene at each frame, the head mounted display device can track the ball's movement and limit the image capture to a region of interest around the ball. The newly captured sensor representation can be joined with the static portions of previously captured representations to produce a new scene. In this way, the number of pixels in each image capture can be reduced.

B. Identifying Regions of Interest with Non-Destructive Readouts

Regions of interest can be identified in image sensor readouts. To perform this functionality, the head mounted display device may need to capture image sensor readouts of at least the field of vision in order to identify these regions of interest. However, if the regions of interest are identified and captured in the same readout type, then the entire field of view is already captured for each scene and combining static regions and regions of interest may not result in energy savings (e.g., reduced power consumption). Instead, the head mounted display device's image sensors may be able to perform two types of image sensor readouts so that the regions of interest can be identified in a low-quality, but energy efficient, readout of at least the field of vision, and captured in a high-quality, but energy intensive, readout of just the regions of interest.

The head mounted display device's image sensors can produce two different readout types. Each pixel in the image sensor can be a complementary metal-oxide semiconductor (CMOS). In operation, the pixel accumulates electrons in a charge well in response to received photons. Once sufficient charge has accumulated in the well, the pixel can perform a readout to generate a sensor representation of the received photons. The first type of readout, a destructive readout clears the charge well (e.g., removes all or substantially all of the charge) and produces a high-quality sensor representation (e.g., a high signal to noise ratio sensor representation). Depleting the charge well consumes energy, because, after depletion, the well must be refilled with a reference charge that is obtained from the image sensor's power source.

In addition, the image sensors may be able to perform a second type of readout called a non-destructive readout. Multiple non-destructive readouts can be performed between each destructive readout. Accordingly, non-destructive readouts are performed over short timeframes, with smaller samples, when compared to destructive readouts. As a result, destructive readouts may have lower signal to noise ratios when compared to non-destructive readouts, because the sample used to generate each non-destructive readout is comparatively small. High quality sensor representations produced from destructive readouts can be suitable for presentation on the head mounted device's display (e.g., the representations are of a sufficient quality that they can be presented to a user). Sensor representations can be analog domain or digital domain representations of a physical environment.

Non-destructive readouts produce a lower quality (e.g., a lower signal to noise) sensor representation by converting the stored charge to a sensor representation without clearing the charge well. Because the charge is not cleared, a non-destructive readout can be performed several times until the well is full and needs to be emptied. The non-destructive readout, by not clearing the charge well, is more energy efficient than a destructive readout that fills and clears the well with each captured representation. Because the charge well is not depleted, the image sensor does not have to supply a reference charge between every non-destructive readout. Therefore, non-destructive readouts consume less power than destructive readouts.

Sensor representations generated from non-destructive readouts may be lower quality than those generated by destructive readouts and the non-destructive representation may not be suitable for display to a user (e.g., because the image is too noisy). However, the non-destructive readouts can be used to identify regions of interest that can be subsequently captured using a destructive readout. For example, the charge from sequential non-destructive readouts can be used to detect whether the light received at each image sensor pixel has changed between readouts. Changes in received light (e.g., the intensity and/or wavelength of received light) at each pixel can be used to identify regions of interest such as a specific object, detected movement, or regions that have otherwise changed. The regions of interest can be regions of a sensor representation where the output of a threshold number of pixels has changed between sequential readouts. The changes in output could include changes in lux levels, or the absence or presence of particular colors. In addition, regions can be identified by the presence or absence of detected edges (e.g., luminescence gradients in a particular direction), or recognized objects. After the regions are identified, the regions of interest can be captured as high-quality sensor representations using destructive readouts. Such techniques can be used to minimize the number of pixels that perform destructive readouts and save energy.

### C. Field of Measurement and Field of View

The field of measurement of the head mounted display device's image sensors can be larger than the field of view of the device's display. The field of view is the extent of the environment that can be shown on the head mounted device's display and the field of measurement is the extent of the environment for which a sensor representation can be generated by the image sensors. Because the user receives visual information through the display, a user may become nauseous, disoriented, or struggle to navigate if the display's image does not update to reflect the user's movement. Accordingly, head mounted display devices can be particularly sensitive to image delay. However, the head mounted display device's comparatively large field of measurement can help mitigate delay errors.

The large sensor field of measurement can allow the head mounted display to identify regions of interest before they enter the display's field of view and reduce image delay errors. For example, a user may be turning her head, and, as her pose changes, an object of interest may enter her field of view. If the field of view and the field of measurement are coextensive, then the head mounted display device may have to both detect a region of interest and capture a high-quality sensor representation of that region in the time between sequential display frames (e.g., the duration of the frame rate of the display device). This time constraint increases the likelihood of errors which can cause the displayed scene to vary from the anticipated scene which can be uncomfortable to the user.

A field of measurement that exceeds the field of view can allow for more time for image processing. A region of interest can be identified as it enters the field of measurement. As the user's pose changes, the head mounted display device can project the region's future location, and, if the region is projected to enter the field of view, a high-quality destructive readout of the region can be performed before the region is displayed. In this way, the head mounted display device can begin image processing before the region of interest enters the field of view.

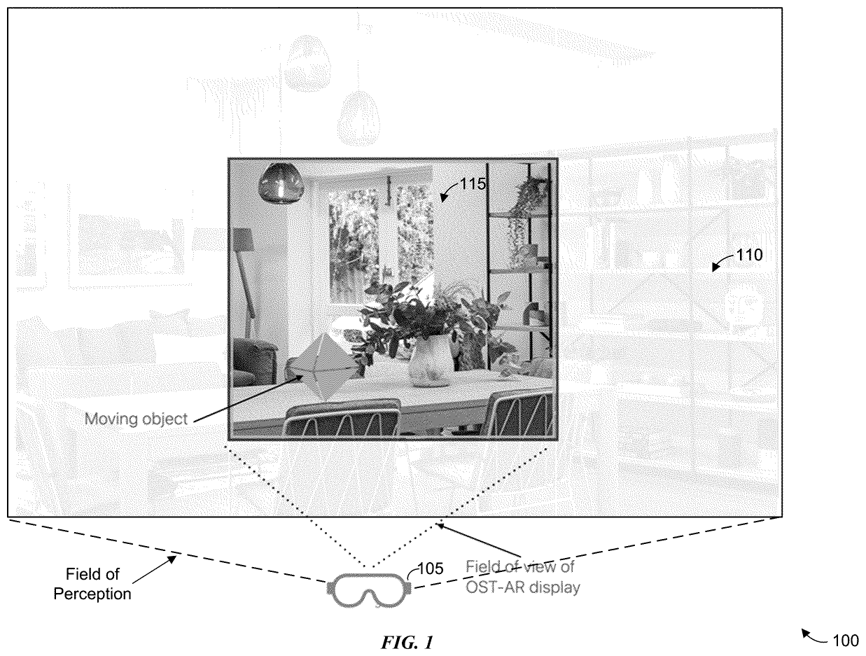

FIG. 1 shows a simplified diagram 100 of a head mounted display's field of view and field of measurement according to at least one embodiment. The head mounted display device 105 is an electronic device that can present an augmented reality scene depicting the user's environment. This scene is a computer enhanced depiction of the user's surroundings, and, while the scene is shown on a device's display, the user looks through the transparent display to see the physical environment below the enhanced depiction.

The scene can be created from readouts captured by the head mounted display device 105. The arc of the environment for which a sensor representation can be created by image sensors of the head mounted display device 105 can be the field of measurement 110. The head mounted display device 105 can perform destructive readouts and non-destructive readouts on any portion of the field of measurement 110. Any number of non-destructive readouts of any region of interest size can be performed from any location in the sensor array. Within the field of measurement 110 is the field of view 115 of the head mounted display device 105.

The field of view 115 can be a portion of the field of measurement 110 that can be shown to a user via a display of the head mounted display device 105. In some embodiments, the field of view 115 can be a fixed portion of the field of measurement 110 (e.g., a region around a center of the field of measurement 110). In other embodiments, the field of view can be dynamic, and the field of view can depend on the pose of the head mounted display device 105 (e.g., the orientation of the device with reference to the floor). In some embodiments, the head mounted display device may track a user's eye movement and the field of view may dynamically change based on where the user is looking.

A destructive readout of the image sensor pixels corresponding to the field of view 115 can be performed to generate a sensor representation that is initially shown to the user on top of the physical environment. For example, the readout can be performed when a user initiates augmented reality functionality, when the user puts on the head mounted display device 105, or when the head mounted display device 105 is powered on. This initial representation can be updated with readouts of regions of interest that are identified using non-destructive readouts.

### D. Non-Destructive Readout to Identify Regions of Interest

As the physical environment changes, the head mounted display device may need to update the initial sensor representation shown in the field of view. For example, a user wearing the display device may change poses and this will cause a corresponding change to the field of view. In addition or alternatively, movement within the field of measurement necessitating an update to the field of view may be detected. The areas requiring updates may be identified as regions of interest within the field of measurement. These regions of interest can be identified in sensor representations generated through non-destructive readouts of the field of measurement. After identification, the head mounted display device can perform a destructive readout to update the field of view.

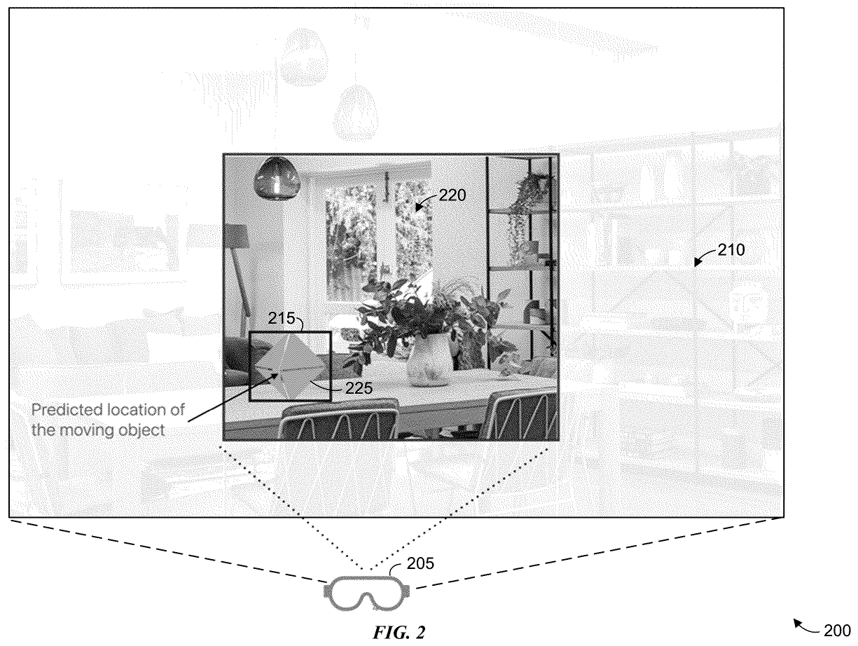

FIG. 2 shows a simplified diagram 200 of a region of interest according to at least one embodiment. As shown in diagram 200, the head mounted display device 205 generates a sensor representation corresponding to the region of measurement 210 (e.g., the entire region within the rectangle including the area within the field of view 220). This non-destructive sensor representation can be captured between updates to the destructive sensor representation shown to the user on the display of head mounted display device 205 (e.g., between image frames).

The head mounted display device 205 may identify a region of interest 215 in the non-destructive sensor representation corresponding to the field of measurement 210. A region of interest can be any area, without a corresponding destructive sensor representation, that is predicted to be within the field of view at the next update time (e.g., the next image frame or change to the representation shown on the device's display). If a user changes poses, a region of the field of view 220 for the changed pose, that was not present in the destructive sensor representation from the previous pose, can be a region of interest.

A destructive readout may be performed for any region of interest that is detected in a non-destructive readout before the next update time. The update time can be a point at which the sensor representation shown on the display device is changed. For example, a display may show 60 frames per second so the update time can be 1/60^{th} of a second. The cadence at which update times occur can be the frame rate of a display device. In some embodiments, the update time (e.g., the duration of the frame rate) may not be a fixed time interval and the update time can be based on a detected event. For example, the destructive sensor representation can be updated in response to detecting a pose change or a prediction, based on non-destructive readouts, that an object will enter the field of view.

Certain categories of objects are identified in the non-destructive readouts because such objects are likely to correspond to regions of interest. Moving objects are identified, and their motion predicted, because such objects are likely to transect the field of view. For example, a moving object 225 can be detected by comparing the objects position in sequential non-destructive readouts. The compared positions can be two dimensional or three dimensional positions. Three dimensional positions can include a distance from the head mounted display device and this distance can be determined by an active depth sensor, by comparing object size changes, or though monocular depth. Once identified, the head mounted display device 205 can track the moving object 225 to determine whether the object will be within the field of view 220 at the next update time. If the object is predicted to enter the field of view, a destructive readout of a region of interest 215 surrounding the object can be captured. In some embodiments, this destructive readout can be performed before the moving object 225 has entered the field of view 220. Other objects can be tracked, and certain objects of interest may be tracked because the user is likely to want to view them and therefore, they are likely to enter the field of view 220.

### E. Destructive Readout of the Identified Regions of Interest

The head mounted display device shows sensor representations of the surrounding physical environment to the device's user. This representation is generated from destructive readouts of the physical environment captured by the device. After an initial destructive readout, additional destructive readouts are performed to update this initial scene with regions of interest that are new or updated. This update procedure allows the head mounted display device to save power by reducing the number of destructive readouts performed by the device.

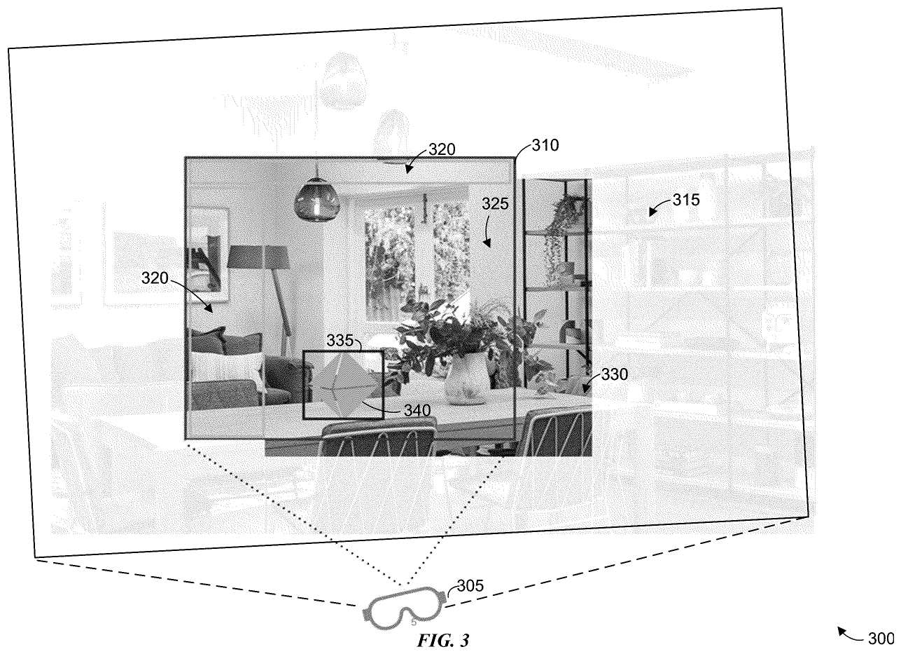

FIG. 3 shows a simplified diagram of an updated field of view according to at least one embodiment. As shown in FIG. 3, the head mounted display device 305 has changed poses after an initial scene has been captured through destructive readouts. The display corresponding to the field of view 310 and the sensors corresponding to the field of measurement 315 can have a fixed relationship to the head mounted display device 305. Accordingly, as the head mounted display device 305 changes poses, the field of view 310 and the field of measurement 315 change as well.

As head mounted display device 305 changes poses, the field of view 310 moves to include regions of interest 320 that were not previously captured by destructive readout. To conserve power, the head mounted display device 305 can attempt to reuse sensor representations generated from destructive readouts, but the device may have to perform destructive readouts for the regions of interest 320 because no valid sensor representation exists for these regions. Accordingly, the display performs a destructive readout to capture a sensor representation of the regions of interest 320 because the device does not have a valid representation of these regions. There may be no valid sensor representation because destructive readouts of the regions of interest 320 were not captured during the current augmented reality session, or previously captured representations are no longer suitable for presentation to a user (e.g., too much time has elapsed since capture).

The head mounted display device 305 can reuse sensor representations from regions that are present at successive update times (e.g., region 325). However, a previously captured region may change between update times, and, accordingly, destructive readout may need to be performed for regions of interest identified within sensor representations of previously captured regions. For example, Region of interest 335 can correspond to a moving object 340. The motion of object 340 can be predicted from previous sensor representations, generated from destructive or non-destructive readouts, and the region of interest 335 can correspond to the predicted position of object 340 at the next update time. In some embodiments, the region of interest 335 can correspond to the position of object 340 at two successive update times (e.g., to capture the previous position for object 340 and the object's current position).

At each update time, the head mounted display device 305 can combine these sensor representations to create a scene that is presented to the user on the device's display. Combining the representations may include performing image processing techniques on the captured images. For example, sensor representation captured at different times, or at different poses, my need to have their brightness adjusted (e.g., because a cloud passed between update times). In addition, computer generated graphics may be superimposed upon the sensor representation of the physical environment. In some embodiments, the head mounted display device 305 may identify regions where graphics will be superimposed, and a destructive readout may not be performed for these identified regions (e.g., because a graphic will be placed on top of the sensor representation).

### II. Imaging System Architecture

An imaging system can be used to implement the augmented reality functionality of the head mounted display device. This architecture can include an image sensor comprising at least a pixel array and an in-sensor processing unit which can output sensor representations of a physical environment. Output from the image sensor can be provided to an image signal processor which can estimate object motion and identify regions of interest within the sensor representations. In addition, the architecture can include an inertial measurement system/visual inertial odometry (IMU/VIO) system to detect changes in the head mounted display device's pose (e.g., the device's orientation and location).

### A. Image Sensor

The imaging system architecture can include an image sensor that can perform either destructive readouts and non-destructive readouts to generate sensor representations of a physical environment that are processed to create a scene. These readouts can be generated by the image sensor's pixel array, and an in-sensor processing unit within the image sensor can process the readouts to identify regions of interest.

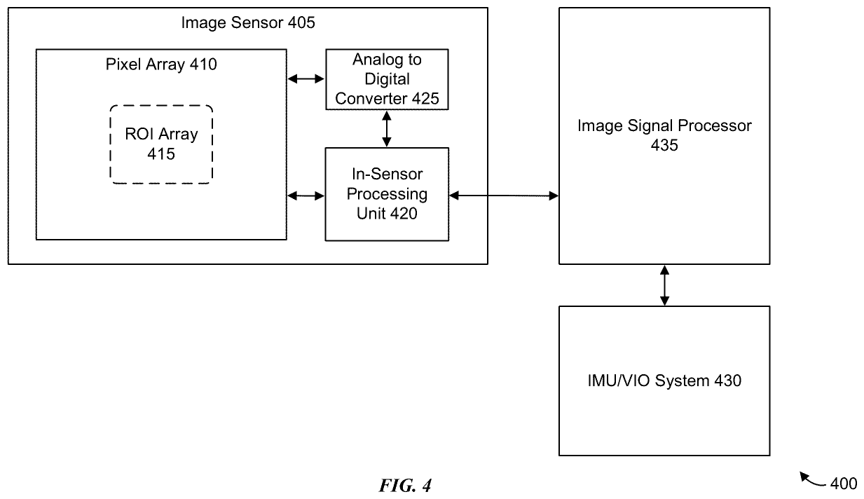

FIG. 4 is a simplified diagram 400 of an imaging system architecture according to at least one embodiment. The image sensor 405 can include any combination of hardware and software for generating a sensor representation of a physical environment. For example, the image sensor 405 can include a pixel array 410 comprising sensors that can measure the intensity and wavelength of received light. For example, each pixel in the array can be a complementary metal oxide semiconductor (CMOS). However, in some implementations, the sensors in some or all of the pixels can be implemented as charge-coupled device (CCD) circuits.

### 1. Pixel Array

The image sensor can create a high-quality sensor representation of a physical environment through a destructive readout. Both CMOS and CCD implemented pixels operate by converting received light into a charge. For example, CMOS pixels can include a photodiode that uses the photoelectric effect to convert photons in the received light into stored charge. This charge can build within the CMOS pixel until a destructive readout is performed and the charge is cleared from the circuit. Each pixel in a CMOS pixel array can be read individually by measuring the voltage of the cleared charge.

CCD pixels operate similarly by storing charge that is generated from received light, however, unlike CMOS circuits, each row in the pixel array 410 is read sequentially and individual pixels cannot be read alone. To read a CCD circuit, a charge reader at one end of a row in a CCD pixel array receives a charge from the proximate pixel. As the charge from the proximate pixel is passed to the charge reader, each pixel in the row passes its charge to a neighboring pixel in the direction of the charge reader. In this way, each pixel's charge is sequentially fed into the charge reader until the row has been read.

The pixel array 410 may use a subset of the pixels to perform a destructive readout. For example, the destructive readout may be performed on a subset of pixels corresponding to a region of interest (ROI) array 415. Using a subset of pixels can conserve energy because each destructive readout consumes power. To drain a CMOS pixel's charge, a gate in the circuit is opened and the charge is drained away and measured as a destructive readout. After the charge has been removed, the circuit is resupplied with a reference charge drawn from the device's power supply. Therefore the device's power is consumed at each destructive readout, and power can be conserved by reducing the number of destructive readouts.

The region of interest array 415 can correspond to any set of pixels in the pixel array 410 that capture a destructive readout at a particular update time. In some embodiments, the region of interest array 415 and the pixel array 410 are separate arrays. A sensor representation (e.g., image frame) can be generated from destructive readout at each update time and the region of interest array 415 can be the pixels that performed the destructive readout (e.g., pixels that have performed a destructive readout between sequential image frames). The region of interest array 415 can be dynamic and the individual pixels in array can change between each destructive readout. For example, the region of interest array 415 can correspond to the field of view for a head mounted display device in some circumstances. In addition, the pixel array 410 can correspond to the field of measurement. The region of interest array 415 may be larger than the field of vision in some embodiments.

Pixels in pixel array 410 can perform non-destructive readouts that do not require draining the charge from the pixel to produce a readout. The non-destructive readouts can be used to identify regions of interest for which sensor representations can be generated by the region of interest array 415. A non-destructive readout and a destructive readout can be performed by the same pixel between update times (e.g., non-destructive readouts can be performed as the pixel fills with charge and a destructive readout can be performed when the pixel is sufficiently charged). In some embodiments, the update times may be dynamic (e.g., triggered by events rather than occurring at fixed intervals), and, in such embodiments, the pixel array may perform sequential non-destructive readouts until a region of interest is identified, or another triggering event occurs, and a destructive readout is triggered. For example, a pose change can be a triggering event.

### 2. In-Sensor Processing Unit

In-sensor processing unit 420 can perform operations on readouts from pixel array 410. The operations can include analyzing, formatting, processing, or transforming the readouts by the in-sensor processing unit 420. In addition, the in-sensor processing unit 420 may be able to perform techniques to identify object or detect motion. For example, the in-sensor processing unit 420 may extract features, associate those features with objects, and detect the objects across sensor representations.

The in-sensor processing unit 420 can perform operations on non-destructive readouts. For example, the in-sensor processing unit 420 can perform operations to identify objects or motion in non-destructive readouts, and these operations can include feature extraction. Features are recognizable patterns in image readouts, and features can include areas where the gradient between the brightness and/or color of non-destructive readouts is large (e.g., edges), edges that change direction sharply (e.g., corners), and edges that change direction smoothly (e.g., blobs). A model or algorithm can recognize a configuration of features as an object, and, by recognizing the object in multiple readouts, the object's movement within the field of measurement can be tracked. Support vector machines (SVMs) or convolutional neural networks can be trained to recognize objects using the extracted features.

Non-destructive readouts can be used to detect motion. The in-sensor processing unit 420 can use identified features to detect motion within a non-destructive readout. For example, motion can be detected a new feature is detected, a previously detected feature changes positions (e.g., the feature is detected at a different set of pixels), or a previously detected feature is no longer detected. In addition or alternatively, motion may be detected by comparing the output of pixels across different non-destructive readouts. Motion may be detected for a set of pixels if the difference in the output magnitude between non-destructive readouts is above a threshold.

The in-sensor processor 420 may assign a confidence score to each identified region of interest. The size of a region of interest can be dynamically set and the size may depend on the assigned confidence score. In some embodiments, the region of interest may be larger for regions with low confidence scores and smaller for regions with high confidence scores. In some embodiments, the size of a region of interest may be set statically with the same size assigned to each region of interest.

Operations can be performed on the readouts in the analog domain or the digital domain. Readouts from the pixels of the pixel array 410 can be output as analog domain signals in some embodiments. These readouts can be converted to digital domain signals by an analog to digital converter 425 before the in-sensor processing unit performs operations on the readouts. The analog to digital converter 425 can sample the analog signal at regular intervals and convert these samples to binary representations of the analog signal that vary with time. In some embodiments, destructive readouts may be converted to the digital domain before the readouts are provided to the in-sensor processing unit 420. The operations of the analog to digital converter 425 can consume power, and non-destructive readouts may be analyzed in the analog domain to conserve power.

### B. IMU/VIO System

Destructive readouts may be triggered by a change in the head mounted display device's pose. As the user adjusts the position of their body, the display device's three-dimensional orientation, or pose, changes and the scene corresponding to the device's display also changes. A user may be disoriented if the displayed image remains static as the user rotates her head. Additionally, the user may struggle to effectively navigate a physical environment while wearing the display device if the displayed scene does not correspond to the user's actual location. Accordingly, after movement is detected, a destructive readout may be performed to create a scene corresponding to the new pose.

### 1. Detecting Motion

Various sensor types can be used to detect motion, and an inertial measurement unit (IMU) system can detect motion by measuring acceleration and other physical phenomena. A visual inertial odometry (VIO) system can use the output from an IMU system and a camera to determine pose changes by comparing the apparent movement of objects in sequential image frames.

### a) Inertial Measurement Unit (IMU)

A inertial measurement unit can be a suite of sensors that detect and characterize movement by measuring changes in physical phenomena. For example, an IMU system can be three accelerometers that detect acceleration along orthogonal axes. Integration, and other mathematical operations, can be performed on these acceleration measurements to calculate the IMU system's position and velocity. Depending on the IMU system's intended application, such systems may include other sensor types such as gyroscopes or magnetometers.

Returning to FIG. 4, IMU/VIO system 430 may be an inertial measurement unit system in some embodiments. This system can monitor for sensor values indicating that the head mounted display device has changed poses. For example, movement may be detected if a sensor value is above a threshold or if a net change in a sensor value is above a threshold. The detected sensor value may be the output of one or more sensors measured between sequential update times (e.g., between contiguous image frames). In some embodiments, detecting the sensor values may include performing mathematical operations on the output of the one or more sensors. For example, integration can be used to calculate a change in position for the inertial measurement unit system and the threshold may be a position change magnitude. IMU/VIO system 430 may include any combination of hardware and software to implement the disclosed IMU techniques.

### b) Visual Inertial Odometry

A visual inertial odometry (VIO) system can use output from an image sensor to determine changes in pose. Features are identified and their positions are correlated across sensor representations. The relative motion of these features can be used to triangulate the image sensor's movement with respect to the features.

A visual inertial odometry system, such as IMU/VIO system 430, may struggle to distinguish between changes in feature position caused by the image sensor's movement and the object corresponding to the feature's movement in the physical environment. Inertial measurements (e.g., the output of an inertial measurement unit system) can be used to distinguish between these two possibilities. In some embodiments, visual odometry may only be performed if the IMU system detects movement above a threshold. In such embodiments, the detected movement can be used to mitigate the risk that the IMU/VIO system 430 mischaracterizes feature movement as image sensor movement, because physical sensor movement is required before visual odometry is performed. After movement is detected, the IMU/VIO system 430 can perform visual odometry to determine if the magnitude of the movement is sufficient to justify updating the scene depicted on the head mounted display device's screen (e.g., the movement is above a threshold). VIO techniques can be performed using destructive or non-destructive readouts.

### 2. Destructive Readout in Response to Motion

A change in a head mounted display device's pose causes a corresponding change to the field of vision. Depending on the magnitude of this change, the image sensor may be instructed to perform a destructive readout of some or all of the changed field of view using secondary intraframe (SIFR), bracketed capture, or single frame capture techniques.

To perform SIFR techniques, two destructive readouts are captured between update times. Each destructive readout is performed sequentially with each frame having a separate exposure time, but both frames are bound by a single start of frame and end of frame. SIFR techniques can reduce motion blur and can consume less power than bracketed capture. In bracketed capture, multiple image frames are captured in sequence in response to a single trigger. Each frame can have a separate exposure time and each frame is bound by a start of frame and end of frame. In single frame capture, a single frame is captured in response to a trigger.

### C. Image Signal Processor

An image signal processor 435 can perform image processing techniques, predict the future positions for regions of interest using a motion model, and implement augmented reality functionality. The image signal processor 435 can be one or more processors and any combination of hardware and software that can implement the techniques of this disclosure.

### 1. Image Processing Techniques

Image signal processor 435 can perform image processing techniques. For example, the image signal processor 435 can combine destructive readouts output from individual pixels into a sensor representation of a physical environment. The techniques performed by the image signal processor 435 can include image processing functionality that is performed on the sensor representation, and, for example, these operations can include color correction, cropping, red eye removal, sharpness adjustment, resolution scaling, noise reduction, correction for lens distortions, segmenting sensor representations, merging sensor representations, and any other image processing techniques. The image signal processor 435 can enhance low light images to enable a user to see in a dark environment (e.g., low-light image enhancement techniques). In addition, the image signal processor 435 can enhance areas within a sensor representation, and, for example, text in a representation may be magnified or enhanced to increase readability (e.g., the text may be enlarged or changed to an easier to read font).

### 2. Motion Model

Recognized regions of interest can be captured using destructive readouts. If a static object is identified as a region of interest in a non-destructive readout, the image signal processor 435 can identify pixels in the array that correspond to the object's real-world location. However, the non-destructive readout represents a past location for a moving object and the image signal processor 435 may need to predict a future position for a moving object. Accordingly, a motion model that can predict a future position for a region of interest may need to be used to perform destructive readouts of a moving object.

Image signal processor 435 can use a motion model to predict a future position for an object. The motion model can identify an object in sequential readouts that are taken at known times. The distance between the object's position at each readout, and the known time between readouts, can be used to calculate a velocity for the object. The position can be in pixel coordinates (e.g., a pixel corresponding to a centroid of the object) and the velocity can be in pixels per second. An acceleration may be calculated by comparing a sequence of calculated velocities. The position for the object can be calculated using the following formula:

$$r = \frac{1}{2} a {t}^{2} + vt + {r}_{0}$$

Where r is the projected future position for the object, a is the acceleration of the object, v is the calculated velocity of the object, a is the calculated acceleration of the object, r₀ is the object's position in the last frame, and t is time. The time between readouts may be sufficiently small that acceleration can be assumed to be zero in some embodiments. If the acceleration is assumed to be zero, the following formula can be used to project the object's position:

$$r = v t + {r}_{0}$$

Using this motion model, the image signal processor 435 can project the object's location at the next update time and identify the pixels corresponding to the projected location. The image signal processor 435 can designate these identified pixels as a region of interest array 415, and the processing unit can instruct the pixels corresponding to the region of interest array 415 to perform a destructive readout.

### 3. Creating a Scene

The image signal processor 435 can perform operations to implement augmented reality functionality. Augmented reality involves the creation and presentation of composite images (e.g., scenes) that combine enhanced or computer-generated images and depictions of a physical environment. The image signal processor 435 can implement augmented reality functionality by performing image processing techniques on destructive readouts, generating computer-generated graphics, and superimposing these sensor representations on a depiction of a physical environment.

Creating a composite image may involve determining a correspondence between features in multiple sensor representations. For example, image signal processor 435 may need to identify overlapping features between two sensor representations in order to combine the two representations into a continuous image. In addition or alternatively, the image signal processor 435 may need to identify the location of features in the device's display so that a second sensor representation can be superimposed on top of a first representation. To implement this functionality, the image signal processor 435 may perform feature extraction to identify common features between sensor representations. The common features in both images can be used as reference points to combine images. In some embodiments, feature extraction may be performed by either image signal processor 435 or in-sensor processing unit 420.

Image signal processor 435 can create the composite image by superimposing sensor representations of regions of interest on a representation of the physical environment. Each region of interest can be a sensor representation that was captured by a destructive readout. When the readout is performed, the in-sensor processing unit 420 can record a coordinate for the region of interest. The coordinate can be the specific pixels within pixel array 410 that were used to capture the destructive readout. Image signal processor 435 can create the composite image by causing a display to present the sensor representation at the location corresponding to the coordinates where the representation was captured. This representation can be a continuous image that was generated by combining multiple sensor representations. In some embodiments, the sensor representations are presented at the locations calculated by the motion model.

### 4. Augmented Reality Functionality

Human's use visual information to perform a number of tasks, however, human eyesight may not function well in some circumstances. An augmented reality device can present an enhanced depiction of a user's surroundings to aid the user in performing various task. For example, a depiction of the surroundings can be processed to help the user see their surroundings or to highlight specific objects.

Augmented reality functionality may be performed in response to a user request. For example, a user may provide input to the head mounted display device to request such functionality. The head mounted display device may include a speaker, and the image signal processor 435 may receive audio input (e.g., spoken commands) via the device's microphone. For example, the user may use a trigger phrase (e.g., “night vision”) or the audio input may be conversational (e.g., “Hey device, it's too dark in here. Can you help me see?”). In some embodiments, the augmented reality functionality may be triggered by an event, and, for example, low-light image enhancement techniques may be performed in response to the ambient light level being below a threshold.

Augmented reality functionality can include image processing techniques to help a user view their surroundings. For example, image signal processor 435 can brighten and enhance sensor representations to help a user see in a low light environment. In addition, a bright environment can be made darker to assist the user. Image processing may be used to change colors in an environment to assist a user who struggles to see certain colors. Image signal processor 435 may use any relevant image processing technique that can allow a user to view an environment more clearly.

Image signal processor 435 may apply graphics to a sensor representation to perform augmented reality functionality. For example, a user may be searching for a particular object (e.g., keys). In response to a request for a particular object, the image signal processor 435 may locate the desired object in a non-destructive readout. If the object is located, the image signal processor 435 may point the user to the object's location by presenting a computer-generated graphic (e.g., arrow) on the display.

The computer-generated graphics can include text. For example, the image signal processor 435 may recognize an object in the user's field of view. The user may be able to interact with this object (e.g., a speaker) through the head mounted display, but the user may not be aware of this functionality. The image signal processor 435 may present a text menu next to the interactive object, and the menu can list potential commands that the user can use to interact with the object. In addition, image signal processor 435 can recognize text in the user's field of view. The recognized text can be enhanced, enlarged, or rewritten in computer graphics so that the user can read the text more easily.

### III. Sequence Diagrams of Destructive Readouts

### A. Destructive Readout of a Region of Interest

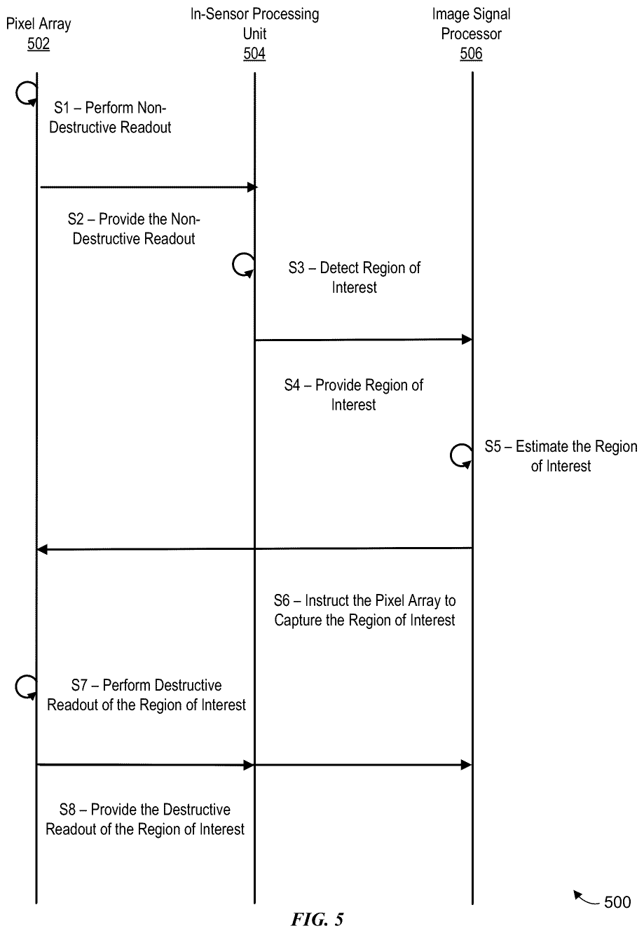

FIG. 5 is a simplified sequence diagram 500 showing a technique for capturing a destructive readout of a region of interest according to an embodiment. Sequence diagram 500 includes a pixel array 502, in-sensor processing unit 504, and image signal processor 506. The description of similarly named components in this disclosure can apply to the pixel array 502, in-sensor processing unit 504, and image signal processor 506 described with relation to sequence diagram 500.

Turning now to sequence diagram 500, at S1 a non-destructive readout can be performed. The non-destructive readout can be performed by the pixel array 502. In some embodiments, a destructive readout may be performed by some or all of the pixels in the pixel array 502 because the charge for some or all of the pixels needs to be cleared before a non-destructive readout can be performed.

At S2, the non-destructive readout can be provided from the pixel array 502 to the in-sensor processing unit 504. The non-destructive readout may be provided in the analog domain or the digital domain.

At S3, the in-sensor processing unit 504 can detect a region of interest in the non-destructive readout received from the pixel array 502. A region of interest can be detected by comparing the non-destructive readout from S2 to one or more previously generated non-destructive readouts or destructive readouts. In some embodiments, the regions of interest can be detected by the image signal processor 506.

At S4, information identifying the detected region of interest can be provided to the image signal processor 506 by the in-sensor processing unit 504. The information identifying the detected region of interest can be coordinates or identified pixels of the pixel array 502 in some embodiments. The non-destructive readout can be provided to the image signal processor 506 by the in-sensor processing unit 504 in some embodiments.

At S5, the image signal processor 506 can estimate the region of interest. Estimating the region of interest can include determining the size of the region of interest and the location of the region of interest. The size of the region of interest can be determined in response to a confidence score for the region of interest. This confidences score can be assigned by a model or algorithm executing on the image signal processor 506. In some embodiments, the in-sensor processing unit 504 can estimate the region of interest and assign a confidence score. The size of a region of interest can be inversely proportional to the confidence score (e.g., the size of the region of interest decreases as the confidence score increases).

AT S6, the image signal processor 506 can instruct the pixel array 502 to capture the region of interest. In some embodiments, this instruction is provided via the in-sensor processing unit 504.

At S7, the pixel array 502 can perform a destructive readout of the region of interest. The destructive readout can be performed by some of all of the pixels in the pixel array 502.

At S8, the destructive readout of the region of interest can be provided to the image signal processor 506. In some embodiments, the destructive readout can be provided to the image signal processor 506 via the in-sensor processing unit 504. The destructive readout may be provided in the analog domain or the digital domain in some embodiments.

### B. Destructive Readout in Response to Movement

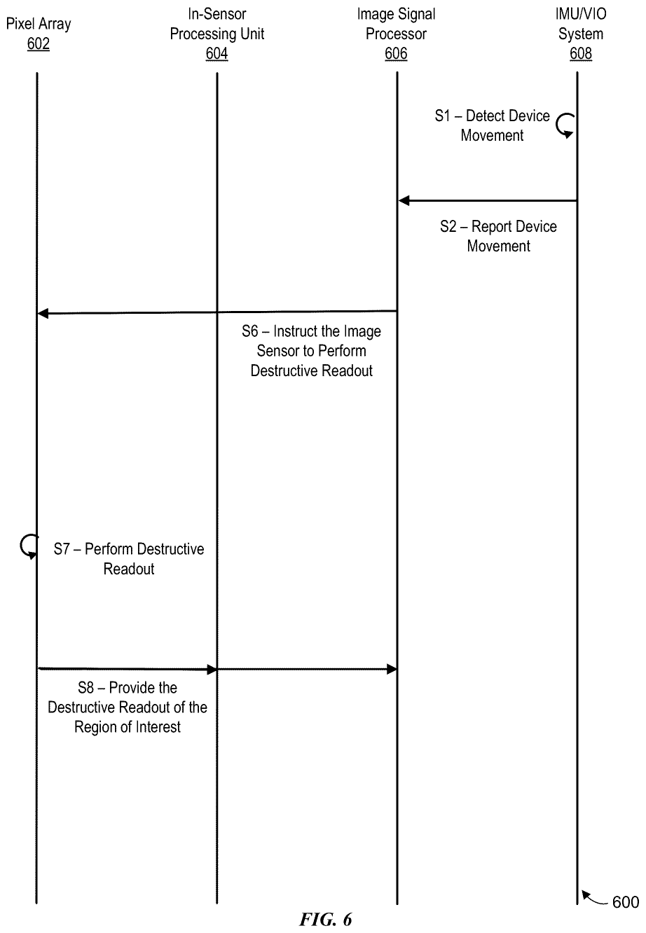

FIG. 6 is a simplified sequence diagram 600 showing a technique for capturing a destructive readout in response to detected movement according to an embodiment. Sequence diagram 600 includes a pixel array 602, in-sensor processing unit 604, image signal processor 606, inertial measurement unit/visual inertial odometry (IMU/VIO) system 608. The description of similarly named components in this disclosure can apply to the pixel array 602, in-sensor processing unit 604, image signal processor 606, IMU/VIO 608 described with relation to sequence diagram 600.

Turning now to sequence diagram 600, at S1 IMU/VIO system 608 can detect device movement. The movement may be detected if a change in the device's position is above a threshold. The device's position can be determined by integrating the device's velocity, and, in some embodiments, movement can be detected if the device's velocity is above a threshold. In some embodiments, movement can be detected if a change in the device's orientation is above a threshold.

At S2, the VIO/IMU system 608 can report the device movement to the image signal processor 606. The VIO/IMU system 608 can report that movement has occurred. In some embodiments, the VIO/IMU system 608 can report a magnitude and direction of the detected movement. For example, the VIO/IMU system 608 can report movement by identifying a new pose for the head mounted display device using a coordinate system (e.g., cartesian coordinates). Reporting movement can include reporting that the device has stopped moving.

AT S3, the image signal processor 606 can instruct the pixel array 602 to capture the region of interest. In some embodiments, this instruction is provided via the in-sensor processing unit 604. The image signal processor 606 can use the reported device movement from S2 to identify a region of interest. For example, a change in pose reported at S2 can be used to determine a corresponding change in the field of vision. The change in the field of vision can cause a new area of the physical environment to enter the field of vision, and these newly added areas can be identified as regions of interest. In some embodiments, if the movement is sufficiently large, the region of interest can correspond to the entire field of vision. Identifying a region of interest can include identifying coordinates for each region of interest. These coordinates can be identified pixels, cartesian coordinates, or any other coordinate system.

At S4, the pixel array 602 can perform a destructive readout of the region of interest. The destructive readout can be performed by some of all of the pixels in the pixel array 602. The pixels performing the region of interest can correspond to regions of interest identified at S3. The destructive readout may be performed using the coordinates identified at S3.

At S5, the destructive readout of the region of interest can be provided to the image signal processor 606. In some embodiments, the destructive readout can be provided in the digital domain or the analog domain. The image signal processor 606 can combine the destructive readout with previously generated destructive readouts to generate a scene. The image signal processor 606 can arrange the destructive readout for each region of interest at a location on the field of view that corresponds to the region of interest. The coordinates identified at S3 may be used to arrange the destructive readouts.

### IV. Techniques for Triggering Destructive Readout

A destructive readout can be triggered by changes to the physical environment corresponding to the field of vision. An initial destructive readout can be triggered by a request for augmented reality functionality. This readout may include the entire field of vision in some embodiments. As the field of vision changes, destructive readouts can be triggered so that the scene shown in the field of vision can be updated. For example, a change in the head mounted display device's pose may trigger a destructive readout because the pose change can cause the physical environment corresponding to the field of vision to change. In addition, destructive readouts can be triggered by other changes to the physical environment. For example, detected movement, identified in a non-destructive readout, can be a trigger for a destructive readout of a region of interest corresponding to the movement.

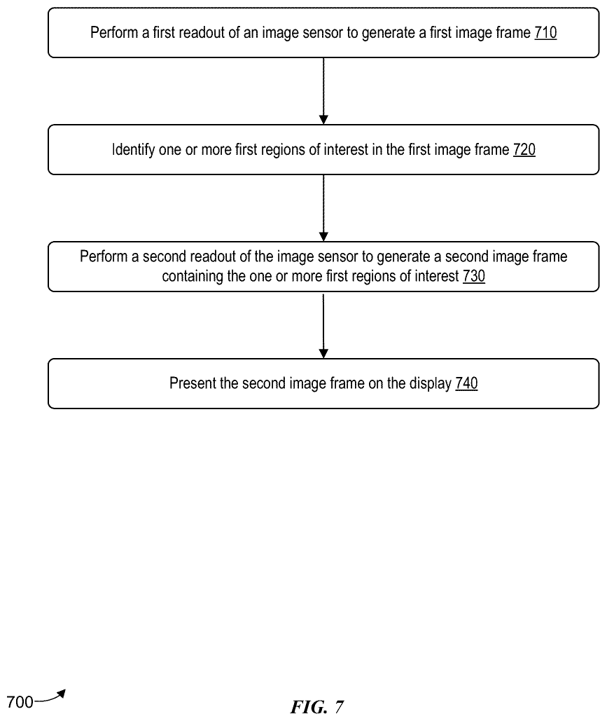

FIG. 7 is a flowchart illustrating a method 700 for performing techniques to trigger a destructive readout of an image sensor according to at least one embodiment. In some implementations, one or more method blocks of FIG. 7 may be performed by an electronic device (e.g., electronic device 800). In some implementations, one or more method blocks of FIG. 7 may be performed by another device or a group of devices separate from or including the electronic device. Additionally, or alternatively, one or more method blocks of FIG. 7 may be performed by one or more components of an electronic device (e.g., electronic device 800), such as imaging system architecture diagram 400, image sensor 405, pixel array 410, analog to digital converter 425, in-sensor processing unit 420, image signal processor 435, IMU/VIO system 430, processor 818, computer readable medium 802, input/output (I/O) subsystem 806, wireless circuitry 808, camera 844, sensors 846, etc.

At block 710, a first readout of an image sensor can be performed to generate a first image frame. The first image frame can be a sensor representation of a physical environment, and the first readout can be a first type of readout. The first type of readout can be a non-destructive readout of an image sensor. The first readout may be performed in response to a request for augmented reality functionality. The first readout may be performed by a head mounted display device. The device can include at least a display, an image sensor, a battery, and a motion sensor (e.g., a IMU/VIO sensor). A sensor representation can be information about the physical environment that is produced from one or more readouts of the image sensor. For example, the sensor representation can be an image in some embodiments.

At block 720, one or more regions of interest can be identified in the first frame generated at 710. The one or more regions of interest can correspond to one or more regions of the physical environment. Regions of interest can include moving objects, one or more recognized objects (e.g., a user's car keys), one or more classes of recognized objects (e.g., car keys generally), humans, animals, text, and visually encoded information (e.g., barcodes or matrix barcodes). The one or more regions of interest may be identified through analysis of a non-destructive readout. The one or more regions of interest can be identified by the first processor. The first processor can be one or more in-sensor processors. In some embodiments, the one or more regions of interest can be identified by a second processor. In some embodiments, the second processor can be one or more device processors.

Regions of interest can be identified using an algorithm executing on the in-sensor processing unit of the image sensor. For example, movement in a region of interest can be identified by comparing the readout from an individual pixel in sequential readouts. If the output of a pixel, or a group of pixels, is sufficiently different between readouts, then a region may contain movement and the region may be flagged as a region of interest.

In addition or alternatively, patterns identified in readouts can be used to recognize and track objects, humans, animals, text, and visually encoded information. These identified patterns, also known as features, can be identified in sequential redouts and movement can be tracked by measuring changes in feature locations. A feature can be a particular configuration of pixels where each pixel has a particular readout. A feature may be identified in a first readout at a first time. This feature can be associated with a recognized object (e.g., a user's car keys), a class of recognized objects (e.g., car keys generally), a human, an animal, text, or visually encoded information (e.g., barcodes or matrix barcodes). The feature can then be identified in a second readout at a second time that may not be contiguous with the first readout (e.g., at least one readout without the feature may occur between the first readout and the second readout). In this way, the entity associated with the feature can be recognized in a readout and a region around the identified feature can be designated as a region of interest.

At block 730, a second readout of the image sensor can be performed to generate a second frame. The second readout can be a second type of readout. The second type of readout can be a destructive readout and a destructive readout may consume more power than a non-destructive readout. The destructive readout may be triggered in response to identifying at least one region of interest at 720. The second image frame can contain the one or more regions of interest identified at 710. The second image frame can be smaller than the display from block 740. The first type of readout can have a first signal-to-noise ratio and the second type of readout can have a second signal-to-noise ratio. The first signal-to-noise ratio can be lower than the second signal-to-noise ratio.

At block 740, the second image generated at 730 can be presented on a display. Presenting the image frame can include performing image processing techniques on the second image frame and presenting the processed second image frame on the display. The image processing techniques can include low-light enhancement techniques. The display can be a transparent display that allows a user of the device to simultaneously view a displayed image frame and the physical environment. Presenting the image frame may include superimposing the second image frame on the one or more first regions of interest corresponding to the one or more regions of the physical environment.

In some embodiments, a third readout of the image sensor can be performed to generate a third image frame. The third readout can be a non-destructive readout of the image sensor. One or more second regions of interest can be identified in the third image frame. Identifying one or more second regions of interest can trigger a fourth readout of the image sensor. The fourth readout of the image sensor can be performed to generate a fourth image frame. The fourth readout can be a destructive readout of the image sensor, and the fourth image frame can comprise the one or more second regions of interest. The second image frame and the fourth image frame can be combined to generate a displayed image frame that can be shown on the display. In some embodiments, the first readout is performed, the one or more first regions of interest are identified, and the second image frame is generated (e.g., one or more of blocks 710-740 are performed) within the duration of the frame rate

Identifying the one or more second regions of interest can comprise identifying one or more objects in both the first image frame and the third image frame. A first set of coordinates can be determined for the one or more objects in the first image frame, and a second set of coordinates can be determined for the one or more objects in the third image frame. These sets of coordinates can be compared to identify a subset of the one or more objects that have changed coordinates between the first image frame and the third image frame. These objects can be identified as the one or more second regions of interest.

In some embodiments, the motion sensor can detect a change of a pose of the head mounted display device. This change of pose can be a trigger for a destructive readout. One or more second regions of interest can be identified based at least in part on the change of the pose. These second regions of interest may not be present in the second image frame. A fourth readout of the image sensor can be performed to generate a fourth image frame. The fourth readout can be a destructive readout of the image sensor, and the fourth image frame comprises the one or more second regions of interest. The fourth image frame can be smaller than the display. The second image frame and the fourth image frame can be combined to generate a displayed image frame that is presented on the display.

A system of one or more electronic devices can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### V. Mobile Device

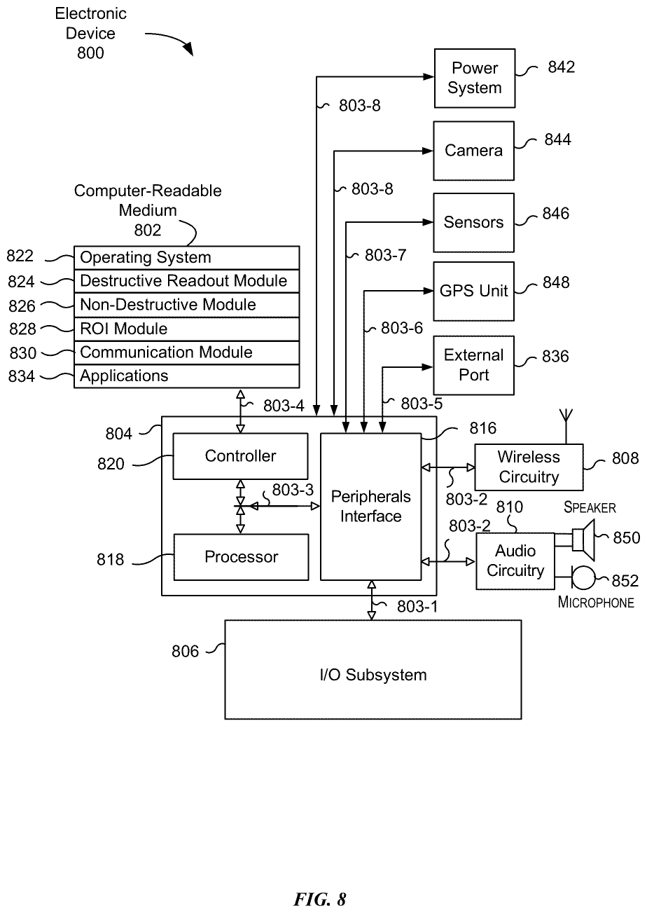

FIG. 8 is a block diagram of an example electronic device 800 (e.g., a computing device) according to at least one embodiment. Device 800 generally includes computer-readable medium 802, a processing system 804, an Input/Output (I/O) subsystem 806, wireless circuitry 808, and audio circuitry 810 including speaker 812 and microphone 814. These components may be coupled by one or more communication buses or signal lines 803. Device 800 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

it should be apparent that the architecture shown in FIG. 8 is only one example of an architecture for device 800, and that device 800 can have more or fewer components than shown, or a different configuration of components. The various components shown in FIG. 8 can be implemented in hardware, software, or a combination of both hardware and software, including one or more signal processing and/or application specific integrated circuits.

Wireless circuitry 808 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 808 can use various protocols, e.g., as described herein. In various embodiments, wireless circuitry 808 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 808 is coupled to processing system 804 via peripherals interface 816. Peripherals interface 816 can include conventional components for establishing and maintaining communication between peripherals and processing system 804. Voice and data information received by wireless circuitry 808 (e.g., in speech recognition or voice command applications) is sent to one or more processors 818 via peripherals interface 816. One or more processors 818 are configurable to process various data formats for one or more application programs 834 stored on medium 802.

Peripherals interface 816 couple the input and output peripherals of device 800 to the one or more processors 818 and computer-readable medium 802. One or more processors 818 communicate with computer-readable medium 802 via a controller 820. Computer-readable medium 802 can be any device or medium that can store code and/or data for use by one or more processors 818. Computer-readable medium 802 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 816, one or more processors 818, and controller 820 can be implemented on a single chip, such as processing system 804. In some other embodiments, they can be implemented on separate chips.

Processor(s) 818 can include hardware and/or software elements that perform one or more processing functions, such as mathematical operations, logical operations, data manipulation operations, data transfer operations, controlling the reception of user input, controlling output of information to users, or the like. Processor(s) 818 can be embodied as one or more hardware processors, microprocessors, microcontrollers, field programmable gate arrays (FPGAs), application-specified integrated circuits (ASICs), or the like.

Device 800 also includes a power system 842 for powering the various hardware components. Power system 842 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 800 includes a camera 844. The camera 844 can be one or more cameras, and, for example, camera 844 can be a camera array. Camera 844 may be capable of performing destructive and non-destructive readouts as described herein. In some embodiments, device 800 includes sensors 846. Sensors can include accelerometers, compass, gyrometer, pressure sensors, audio sensors, light sensors, barometers, and the like. Sensors 846 can be used to sense location aspects, such as auditory or light signatures of a location.

In some embodiments, device 800 can include a GPS receiver, sometimes referred to as a GPS unit 848. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 818 run various software components stored in medium 802 to perform various functions for device 800. In some embodiments, the software components include an operating system 822, a destructive readout module 824 (or set of instructions), a non-destructive module 826 (or set of instructions), a region of interest (ROI) module 828 that is used as part of image capture techniques described herein, and other application programs 834 (or set of instructions).

Operating system 822 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 830 facilitates communication with other devices over one or more external ports 836 or via wireless circuitry 808 and includes various software components for handling data received from wireless circuitry 808 and/or external port 836. External port 836 (e.g., universal serial bus (USB), FireWire, Lightning connector, 80-pin connector, etc.) is adapted for coupling directly to other devices or indirectly over a network (e.g., the Internet, wireless local area network (LAN), etc.).

Destructive readout module 824 can assist in performing an interpreting destructive readouts of image sensors (e.g., camera 844 and sensors 846). Non-destructive readout module 826 can assist in performing an interpreting non-destructive readouts of image sensors (e.g., camera 844 and sensors 846). ROI module 828 can assist in identifying regions of interest using destructive readouts of image sensors and non-destructive readouts of image sensors.

The one or more applications 834 on device 800 can include any applications installed on the device 800, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 806 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments. The display system can be configured to display (e.g., show or present) image frames at a frame rate. The time between sequential image frames can be the duration of the frame rate.

In some embodiments, I/O subsystem 806 can include a display and user input devices such as a keyboard, mouse, and/or trackpad. In some embodiments, I/O subsystem 806 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 802) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 806 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 800 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid-state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine a dwell spot using distance measurements that track a user through their daily routine. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method performed by an electronic device having a display configured to present image frames at a frame rate and an image sensor with a first processor and a second processor:
performing a first readout of an image sensor to generate a first image frame comprising a sensor representation of a physical environment, wherein the first readout is a first type of readout of the image sensor;
identifying, by the first processor, one or more first regions of interest in the first image frame, the one or more first regions of interest corresponding to one or more regions of the physical environment;
performing a second readout of the image sensor to generate a second image frame, wherein the second readout is a second type of readout of the image sensor, and the second image frame comprises the one or more first regions of interest, wherein the first type of readout and the second type of readouts are different readout types; and
presenting the second image frame on the display.

2. The method of claim 1, wherein the first processor is an in-sensor processor, and the second processor is a device processor.

3. The method of claim 1, wherein presenting the second image frame comprises:
performing image processing techniques on the second image frame to produce a processed second image frame; and
presenting the processed second image frame on the display.

4. The method of claim 1, further comprising:
performing a third readout of the image sensor to generate a third image frame, wherein the third readout is the first type of readout of the image sensor,
identifying one or more second regions of interest in the third image frame;
performing a fourth readout of the image sensor to generate a fourth image frame, wherein the fourth readout is the second type of readout of the image sensor, and the fourth image frame comprises the one or more second regions of interest, wherein the fourth image frame is smaller than the display;
combining the second image frame and the fourth image frame to generate a displayed image frame; and
presenting the displayed image frame on the display.

5. The method of claim 4, wherein identifying the one or more second regions of interest comprises:
identifying one or more objects in both the first image frame and the third image frame;
determining a first set of coordinates for the one or more objects in the first image frame;
determining a second set of coordinates for the one or more objects in the third image frame;
comparing the first set of coordinates and the second set of coordinates to identify a subset of the one or more objects that have changed coordinates between the first image frame and the third image frame; and
identifying the subset of the one or more objects as the one or more second regions of interest.

6. The method of claim 1, wherein the electronic device is a head mounted display device comprising at least the display, the image sensor, a battery, and a motion sensor.

7. The method of claim 6, further comprising:
detecting, by the motion sensor, a change of a pose of the head mounted display device;
identifying one or more second regions of interest based at least in part on the change of the pose, wherein the one or more second regions of interest are not present in the second image frame;
performing a fourth readout of the image sensor to generate a fourth image frame, wherein the fourth readout is the second type of readout of the image sensor, and the fourth image frame comprises the one or more second regions of interest, wherein the fourth image frame is smaller than the display;
combining the second image frame and the fourth image frame to generate a displayed image frame; and
presenting the displayed image frame on the display.

8. The method of claim 6, wherein the display is a transparent display permitting a user of the electronic device to simultaneously view a displayed image frame and the physical environment.

9. The method of claim 8, wherein presenting the second image frame comprises:
superimposing the second image frame on the one or more first regions of interest corresponding to the one or more regions of the physical environment.

10. The method of claim 1, wherein the second image frame is smaller than the display.

11. The method of claim 1, wherein the first type of readout is a non-destructive readout and the second type of readout is a destructive readout.

12. A computing device, comprising:
one or more memories; and
one or more processors in communication with the one or more memories and configured to execute instructions stored in the one or more memories to perform operations comprising:
performing a first readout of an image sensor to generate a first image frame comprising a sensor representation of a physical environment, wherein the first readout is a first type of readout of the image sensor;
identifying, by a first processor, one or more first regions of interest in the first image frame, the one or more first regions of interest corresponding to one or more regions of the physical environment;
performing a second readout of the image sensor to generate a second image frame, wherein the second readout is a second type of readout of the image sensor, and the second image frame comprises the one or more first regions of interest, wherein the first type of readout and the second type of readouts are different readout types; and
presenting the second image frame on a display.

13. The computing device of claim 12, wherein the operations to present the second image frame comprise:
performing image processing techniques on the second image frame to produce a processed second image frame; and
presenting the processed second image frame on the display.

14. The computing device of claim 12, the operations further comprising:
performing a third readout of the image sensor to generate a third image frame, wherein the third readout is the first type of readout of the image sensor,
identifying one or more second regions of interest in the third image frame;
performing a fourth readout of the image sensor to generate a fourth image frame, wherein the fourth readout is the second type of readout of the image sensor, and the fourth image frame comprises the one or more second regions of interest, wherein the fourth image frame is smaller than the display;
combining the second image frame and the fourth image frame to generate a displayed image frame; and
presenting the displayed image frame on the display.

15. The computing device of claim 14, wherein the operations to identify the one or more second regions of interest comprise:
identifying one or more objects in both the first image frame and the third image frame;
determining a first set of coordinates for the one or more objects in the first image frame;
determining a second set of coordinates for the one or more objects in the third image frame;
comparing the first set of coordinates and the second set of coordinates to identify a subset of the one or more objects that have changed coordinates between the first image frame and the third image frame; and
identifying the subset of the one or more objects as the one or more second regions of interest.

16. The computing device of claim 12, wherein the computing device is a head mounted display device comprising at least the display, the image sensor, a battery, and a motion sensor.

17. The computing device of claim 16, the operations further comprising:
detecting, by the motion sensor, a change of a pose of the head mounted display device;
identifying one or more second regions of interest based at least in part on the change of the pose, wherein the one or more second regions of interest are not present in the second image frame;
performing a fourth readout of the image sensor to generate a fourth image frame, wherein the fourth readout is the second type of readout of the image sensor, and the fourth image frame comprises the one or more second regions of interest, wherein the fourth image frame is smaller than the display;
combining the second image frame and the fourth image frame to generate a displayed image frame; and
presenting the displayed image frame on the display.

18. A computer-readable medium storing a plurality of instructions that, when executed by one or more processors of a computing device, cause the one or more processors to perform operations comprising:
performing a first readout of an image sensor to generate a first image frame comprising a sensor representation of a physical environment, wherein the first readout is a first type of readout of the image sensor;
identifying, by a first processor, one or more first regions of interest in the first image frame, the one or more first regions of interest corresponding to one or more regions of the physical environment;
performing a second readout of the image sensor to generate a second image frame, wherein the second readout is a second type of readout of the image sensor, and the second image frame comprises the one or more first regions of interest, wherein the first type of readout and the second type of readouts are different readout types; and
presenting the second image frame on a display.

19. The computer-readable medium of claim 18, wherein the operations to present the second image frame comprise:
performing image processing techniques on the second image frame to produce a processed second image frame; and
presenting the processed second image frame on the display.

20. The computer-readable medium of claim 18, the operations further comprising:
performing a third readout of the image sensor to generate a third image frame, wherein the third readout is the first type of readout of the image sensor,
identifying one or more second regions of interest in the third image frame;
performing a fourth readout of the image sensor to generate a fourth image frame, wherein the fourth readout is the second type of readout of the image sensor, and the fourth image frame comprises the one or more second regions of interest, wherein the fourth image frame is smaller than the display;
combining the second image frame and the fourth image frame to generate a displayed image frame; and
presenting the displayed image frame on the display.
